(19) United States
(12) Patent Application Publication
(10) Pub. No.: US 2014/0135660 A1
(43) Pub. Date: May 15, 2014

(54) Therapeutic Method of Indirectly Relieving Localized Pain

(71) Applicant: Eric E. BERG, Alexandria, VA (US)

(72) Inventor: Eric E. BERG, Alexandria, VA (US)

(21) Appl. No.: 14/080,736

(22) Filed: Nov. 14, 2013

Related U.S. Application Data
(60) Provisional application No. 61/726,117, filed on Nov. 14, 2012.

(51) Int. Cl. A61H 99/00

(52) U.S. Cl. CPC A61H 99/00
USPC 601/1

(57) ABSTRACT

A therapeutic method that indirectly reliefs localized pain on a human body utilizes the neural circuitry that links agonist muscles to antagonist muscles and utilizes the neural circuitry that cross-links the left side of the body to the right side of the body. First, a practitioner of this method identifies the painful region on the human body and locates the mirroring region on the human body across the mid-sagittal plane. The practitioner will then stimulate the mirroring region to remedy the painful region. Second, the practitioner locates the contralateral region to the painful region about its respective body part. The practitioner will then stimulate the contralateral region in order to remedy the painful region.

The current application claims a priority to the U.S. Provisional Patent application Ser. No. 61/726,177 filed on Nov. 14, 2012.

### FIELD OF THE INVENTION

The present invention relates generally to a manual therapy method. More specifically, the present invention is a method that focuses on treating the body region that lies directly opposite the problematic region on the body. The manual method of the present invention is based upon the nerve cross over principle of reciprocal inhibition and spinal cord reflexes in which triggering or contracting of an agonist muscle will affect and relax its antagonist (or opposite) muscle. This invention is in the application of this principle towards the alleviation of chronic and acute pain. Through stimulating the area on the body opposite or mirror image to the pain on the same limb, one can reduce the affected pain area. This is due to the reciprocal circuits neurologically. This invention can also be applied to the left and right side of the body in which trigger of the opposite area of one limb, can reduce the pain of the affected limb.

### BACKGROUND OF THE INVENTION

Manual therapy is commonly used in the treatment of both chronic and acute pain of the body resulting from injury, surgery, and other conditions. Most therapy is applied directly to the problematic body region and commonly involves manipulation or physical therapy or massage of the spine, joints, and tissues of patients to alleviate pain. Injury or trauma to a body region often results in neighboring protective muscles forcing the region into a guarded mode and inappropriate chronic pain long after the injury. Muscle guarding significantly debilitates and slows the healing and rehabilitation process of an affected body region. Direct stimulation and treatment of the problematic region can potentially result in aggravation of the injury, trauma, or condition and worsen muscle guarding. However, although affected tissues may heal within a matter of weeks, the neurological component of the injury may continue with heightened guard mode of the affected region. This causes the problematic body region to become susceptible to re-injury. The present invention seeks to improve upon the current manual methods by releasing the protective guarding and inappropriate pain impulses.

It is therefore the object of the present invention to circumvent the concern of inappropriate muscle guarding aggravation and chronic pain resulting from direct treatment of an affected body region. The present invention is a manual method that focuses on treatment of the body region that is directly opposite the problematic region on the body. The first option for providing pain relief generally encompasses stimulation of the opposite region (mirror image) of the body as that of the problematic region. The present invention is based on physiological phenomenon of reciprocal inhibition in which an agonist muscle contracts or is otherwise stimulated, forcing the antagonist muscle directly opposite the agonist muscle to relax. Every muscle pain and body part is neurologically connected on the same neuro-circuit, thus influence one side affects the opposite side. This invention has yielded benefits such as faster pain relief, greater range of motion, faster recovery from injury, reduced body stress, faster recovery from surgery, increased flexibility, increased mobility, reduced number of required treatments for recovery, and less pain from chronic inflammation. There is two options for providing manual therapy for pain relief are (1) involving stimulation of the opposite side of the limb of the pain area on the same side of the body and (2), stimulating the opposite side of the body that is in the pain. An alternative embodiment of the first option for pain relief involves stimulation of the opposite proximal muscle of the agonist muscle.

In addition to pain relief, the manual therapy method of the present invention is applicable to situations involving restriction of motion. The region and direction of restricted motion is identified and isolated. The region of restricted motion is then stretched in the direction opposite the restriction.

The manual therapy method of the present invention is applicable to the treatment of muscle spasms as well. Pursuant to the principle of reciprocal inhibition, the antagonist muscle on the opposite side of the body as the problematic agonist muscle is stimulated. Alternatively, the muscle opposing the problematic muscle on the same body part may be stimulated.

The manual therapy method of the present invention involves the identification and isolation of the problematic region prior to treatment. Therapy is then applied to the direct opposite/mirror region of the affected body area. General manual therapy such as massage, stretching, and other manipulation is applied to the affected region. As therapy is applied to the opposite/mirror muscles of the problematic region, signals are transmitted to the area of the problematic region causing the affected pain to be reduced.

### BRIEF DESCRIPTION OF THE DRAWINGS

FIG. 1 is a flow chart showing the overall method of the present invention.

FIG. 2 is a flow chart showing the joint pain-relief method of the present invention.

FIG. 3 is a flow chart showing the relaxant method of the present invention.

FIG. 4 is a diagram of a human body showing the definitions used in the present invention.

FIG. 5 is a diagram showing how to relief pain on a medial spot on the left elbow by stimulating the mirroring region on the right elbow.

FIG. 6 is a diagram showing how to relief pain on the left side of the forehead by stimulating the mirroring region on the forehead.

FIG. 7 is a diagram showing how to relief pain on a medial spot on the left elbow by stimulating the contralateral region about the left elbow.

FIG. 8 is a diagram showing how to relief pain on the left side of the forehead by stimulating the contralateral region at the back of the head.

FIG. 9 is a diagram showing how to relief pain on a medial spot on the right knee by finding the contralateral region of the mirroring region and by stimulating the proximal muscle group near that contralateral region.

FIG. 10 is a diagram showing how to relief pain on a spastic region on the front of the neck by stretching the back of the neck.

### DETAILED DESCRIPTIONS OF THE INVENTION

All illustrations of the drawings are for the purpose of describing selected versions of the present invention and are not intended to limit the scope of the present invention.

The present invention is a therapeutic method of indirectly relieving localized pain on a human body 1. The present invention is designed to reduce chronic pain (or altered sensation), inflammation, and muscle guarding in the human body 1. The present invention is also designed to increase the range of motion after the human body 1 experiences injury or surgery. This therapeutic method utilizes the neural circuitry that links agonist muscles to antagonist muscles and utilizes the neural circuitry that cross-links the left side of the body to the right side of the body. Consequently, the present invention treats the localized pain without making direct contact and may prevent further aggravating the localized pain. The present invention can be used to reduce the following ailments: reflex sympathetic dystrophy syndrome or complex regional pain syndrome, phantom pain, neuroma, lower back pain or stiffness, neck pain, torticollis, shoulder pain, elbow pain, wrist pain, carpal tunnel syndrome, hand pain, finger pain, rib pain, chest pain (non-heart related), abdominal pain, hip pain, knee pain, ankle pain (chronic and acute), foot pain, plantar fasciitis, toe pain, muscle spasm or stiffness, and frozen shoulder.

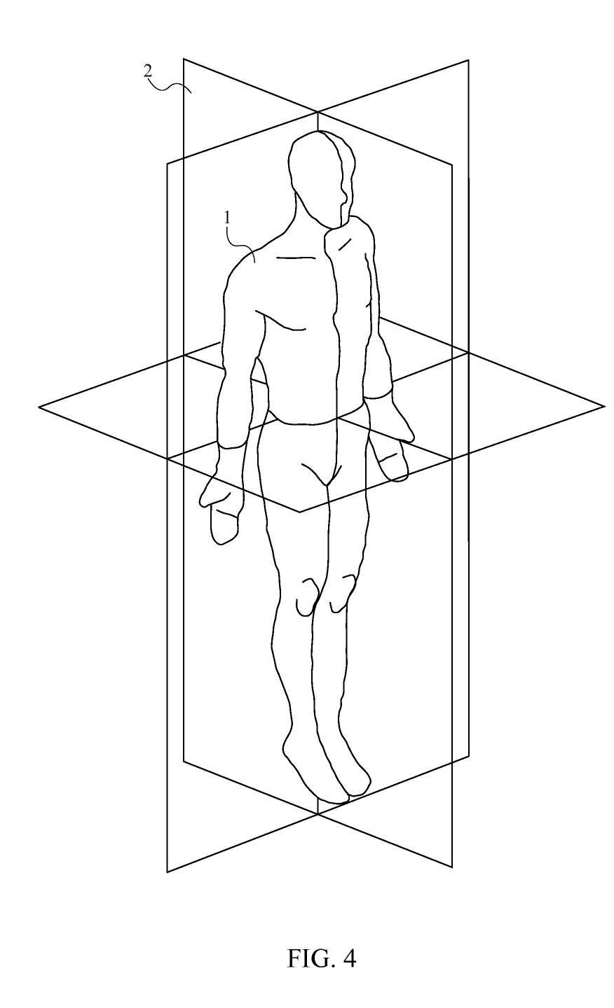

The present invention follows procedural steps in order to indirectly relieve localized pain on a human body 1 and requires some preliminary definitions to adequately describe these procedural steps. As can be seen in FIG. 4, the therapeutic method should be enacted upon a human body 1, which is symmetrically and bilaterally defined by a mid-sagittal plane 2. The therapeutic method could also be implemented on animals with similar structural symmetry as a human body 1. The mid-sagittal plane 2 is a vertical plane that traverses from the front to the back of the human body 1 and evenly divides the human body 1 into even left and right halves. In addition, the human body 1 needs to be anatomically defined as a plurality of distinct body parts so that a practitioner can accurately identify particular areas on the human body 1 while implementing those procedural steps. In the preferred embodiment of the present invention, the plurality of body parts includes, but is not limited to, a head, a neck, a torso, a left arm, a left elbow, a left shoulder, a right arm, a right elbow, a right shoulder, a left leg, a left knee, a left hip, a right leg, a right knee, and a right hip.

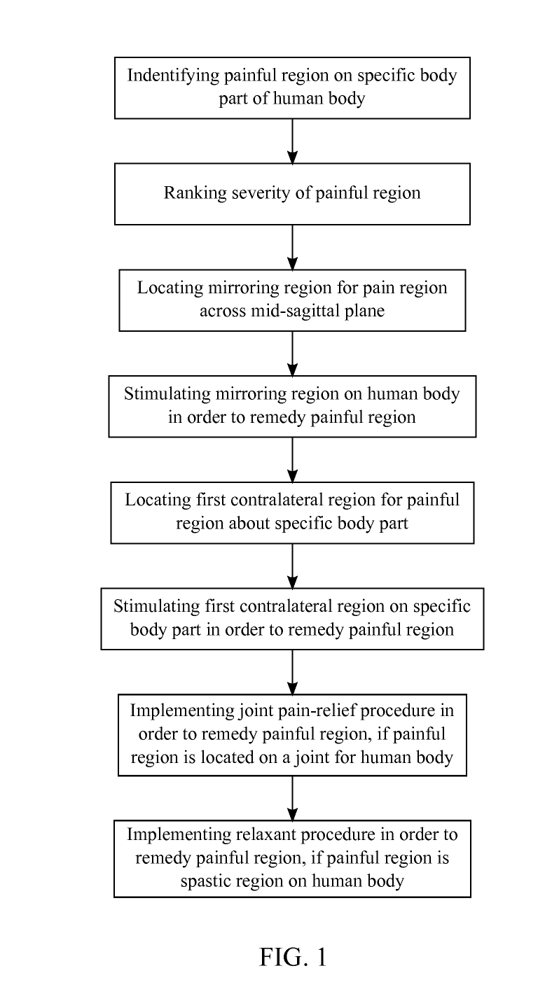

As can be seen in FIG. 1, the procedural steps allow a chiropractor, a physical therapist, a masseuse/masseur, or any other physiological practitioner to implement the present invention. A practitioner begins the therapeutic method by identifying a painful region 3 on a specific body part 4 of the human body 1. In some circumstances, the painful region 3 on the human body 1 can be visually identified by the practitioner, subjectively or tactually identified by the patient, or identified by some other medical means. The practitioner continues with the therapeutic method by ranking the severity of the painful region 3, which allows the patient to determine the effectiveness of the therapeutic method. Again, the ranking of the painful region 3 can be visually completed by the practitioner (i.e. reddish swelling on the patient), tactually completed by the patient, or completed by some other medical means. In the preferred embodiment of the present invention, the severity of the painful region 3 is ranked on a scale of 0 to 10, wherein a ranking of 0 represent no pain and a ranking of 10 represents extreme pain.

Another ranking for the severity of the painful region 3 can be assessed at the end of the therapeutic method in order to determine if the severity of the painful region 3 decreased for the patient and whether or not the therapeutic method needs to be repeated on the patient.

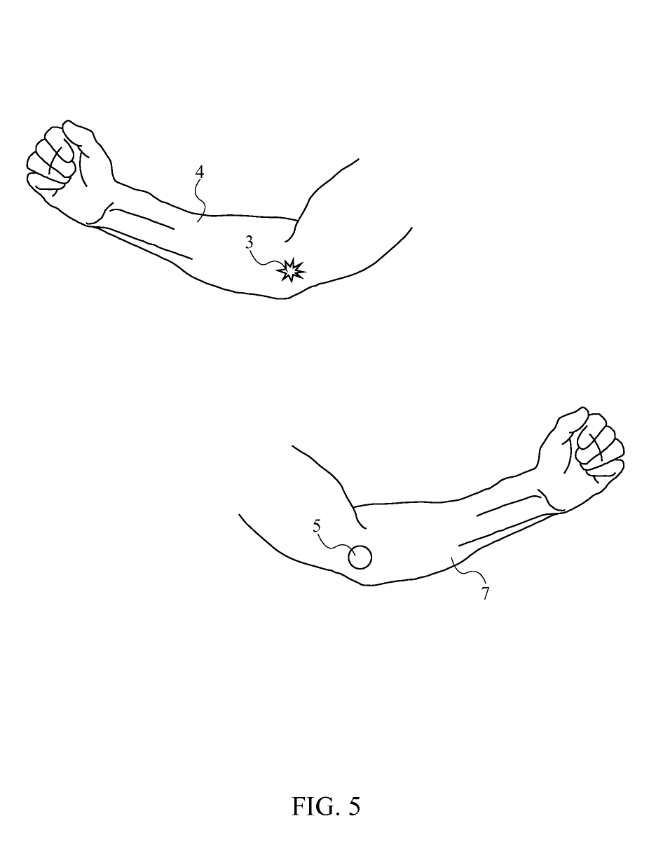

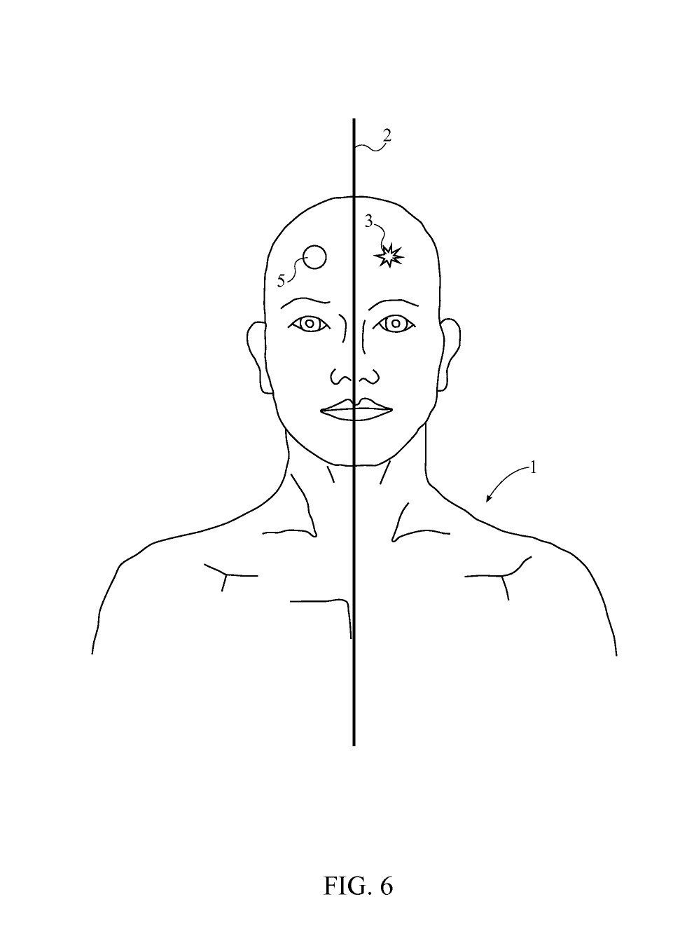

The next series of the procedural steps is an effort by the present invention to remedy the painful region 3. First, the practitioner needs to locate a mirroring region 5 for the painful region 3 across the mid-sagittal plane 2. For example, if the painful region 3 on the human body 1 is a medial spot on the left elbow, then the mirroring region 5 is the same medial spot on the right elbow, which is shown in FIG. 5. Also for example, if the painful region 3 on the human body 1 is the left portion of the forehead, then the mirroring region 5 is the right portion of the forehead, which is shown in FIG. 6. Second, the practitioner stimulates the mirroring region 5 on the human body 1 in order to remedy the painful region 3. For example, if the painful region 3 on the human body 1 is the medial spot on the left elbow, then the practitioner would pressure and massage the same medial spot on the right elbow. Also for example, if the painful region 3 on the human body 1 is the left portion of the forehead, then the practitioner would pressure and massage the right portion of the forehead. In the preferred embodiment of the present invention, stimulating the mirroring region 5 can be accomplished by pressuring and massaging the mirroring region 5 for 30 to 60 seconds. The amount of pressure applied by the practitioner on the human body 1 should be tolerable by the patient and should not be too light but not unbearable. In other embodiments, stimulating the mirroring region 5 can be accomplished by deep massage, trigger point therapy, manual therapy, rubbing, a press-and-hold technique, and other similar stimulations.

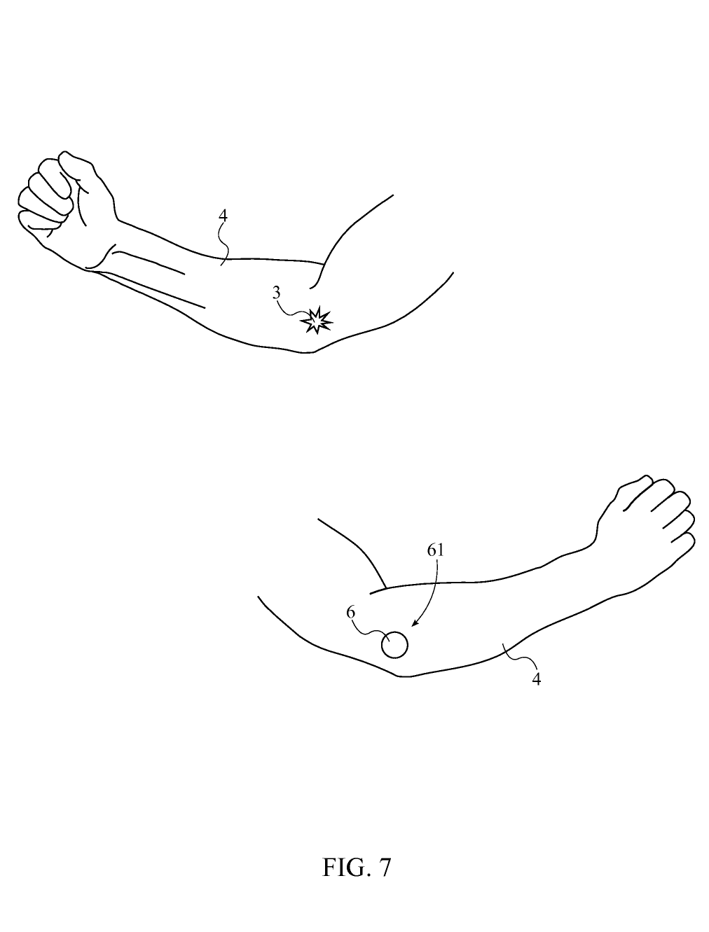

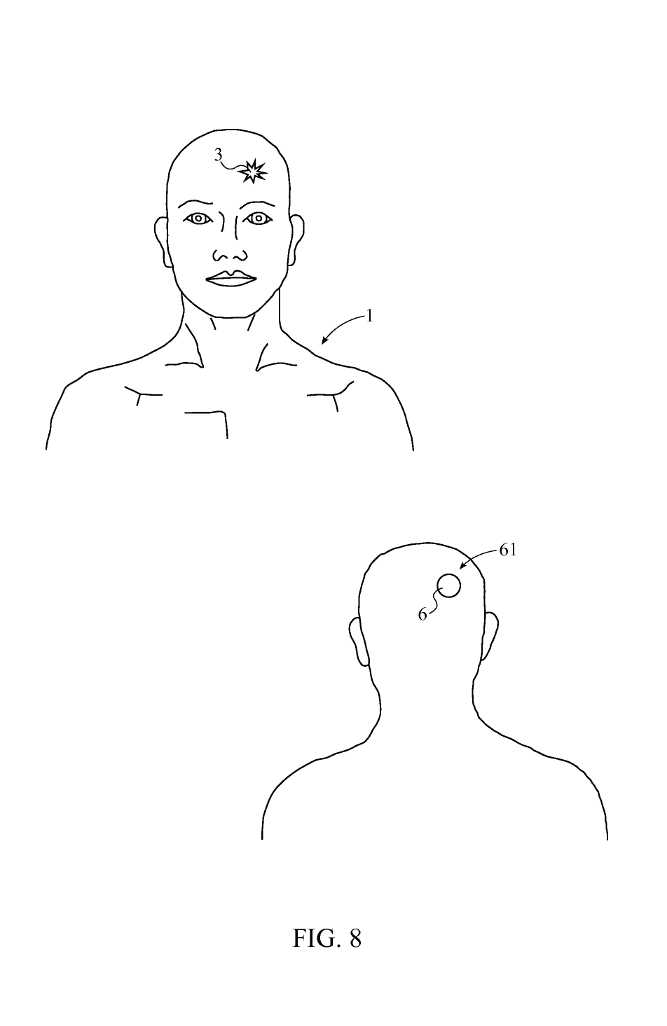

The next series of procedural steps is another effort by the present invention to remedy the painful region 3. First, the practitioner needs to locate a first contralateral region 6 for the painful region 3 about the specific body part 4. For example, if the painful region 3 on the human body 1 is a medial spot on the left elbow, then the first contralateral region 6 is the corresponding lateral spot on the left elbow, which is shown in FIG. 7. Also for example, if the painful region 3 on the human body 1 is the left portion of the forehead, then the first contralateral region 6 is the corresponding left portion at the back of the head, which is shown in FIG. 8. Second, the practitioner stimulates the first contralateral region 6 on the specific body part 4 in order to remedy the painful region 3. For example, if the painful region 3 on the human body 1 is the medial spot on the left elbow, then the practitioner would pressure and massage the corresponding lateral spot on the left elbow. Also for example, if the painful region 3 on the human body 1 is the left portion of the forehead, then the practitioner would pressure and massage the corresponding left portion at the back of the head. In the preferred embodiment of the present invention, stimulating the first contralateral region 6 can be accomplished by pressuring and massaging the mirroring region 5 for 30 to 60 seconds. In other embodiments, stimulating the first contralateral region 6 can be accomplished by deep massage, trigger point therapy, manual therapy, rubbing, a press-and-hold technique, and other similar stimulations. In addition, the practitioner can stimulate the areas 61 around the first contralateral region 6 on the human body 1. For example, if the painful region 3 on the human body 1 is the medial spot on the left elbow, then the practitioner would pressure and massage the biceps tendon or the triceps tendon near the first contralateral region 6.

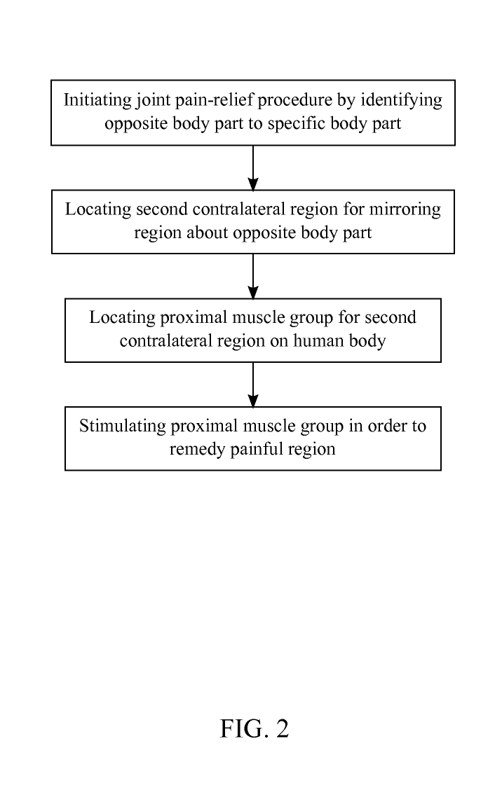

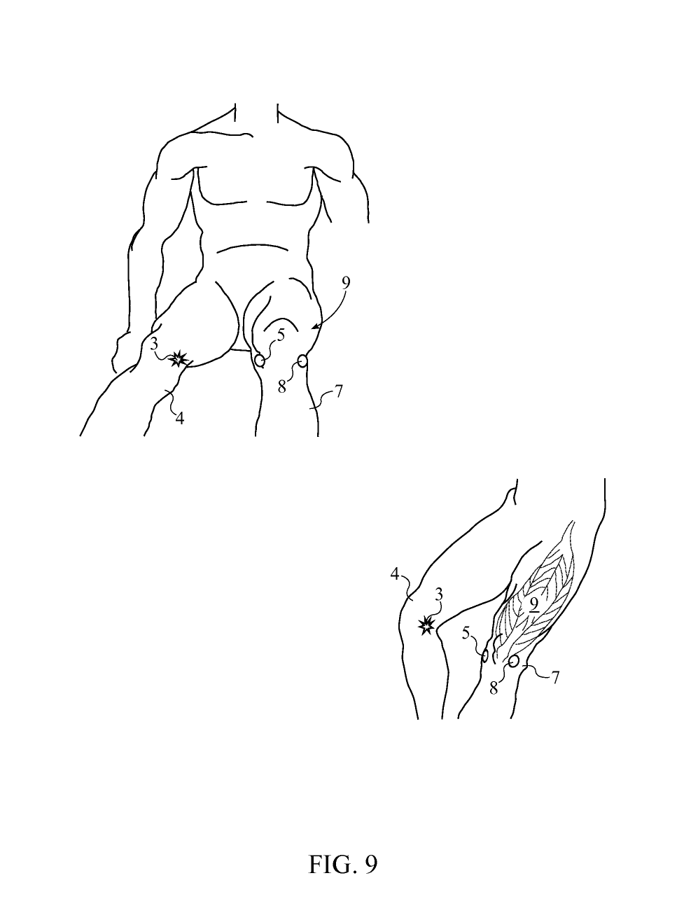

The present invention is also designed to remedy the painful region 3 by gearing specific procedures towards a certain kind of body part. If the painful region 3 is located at a joint of the human body 1, then the practitioner could implement a joint-relief procedure in order to remedy the painful region 3, which is illustrated in FIG. 2. The practitioner initiates this procedure by identifying an opposite body part 7 to the specific body part 4 across the mid-sagittal plane 2, wherein the mirroring region 5 is on the opposite body part 7. For example, if the painful region 3 is a medial spot on the left knee, then the opposite body part 7 will be identified as the right knee. The practitioner will then locate a second contralateral region 8 for the mirroring region 5 about the opposite body part 7. For example, if the painful region 3 is a medial spot on the left knee, then the mirroring region 5 will be located on the medial spot of the right knee and the second contralateral region 8 will be located on the corresponding lateral spot of the right knee, which is shown in FIG. 9. The practitioner will continue the joint pain-relief procedure by locating a proximal muscle group 9 for the second contralateral region 8 on the human body 1. For example, if the second contralateral region 8 is the lateral spot of the right knee, then the proximal muscle group 9 on the right leg would include the vastus lateralis, the rectus femoris, and the iliotibial band. Finally, the practitioner would stimulate the proximal muscle group 9 in order to remedy the painful region 3. For example, if the second contralateral region 8 is the lateral spot of the right knee, then the practitioner would pressure and massage the vastus lateralis, the rectus femoris, and the iliotibial band on the right leg.

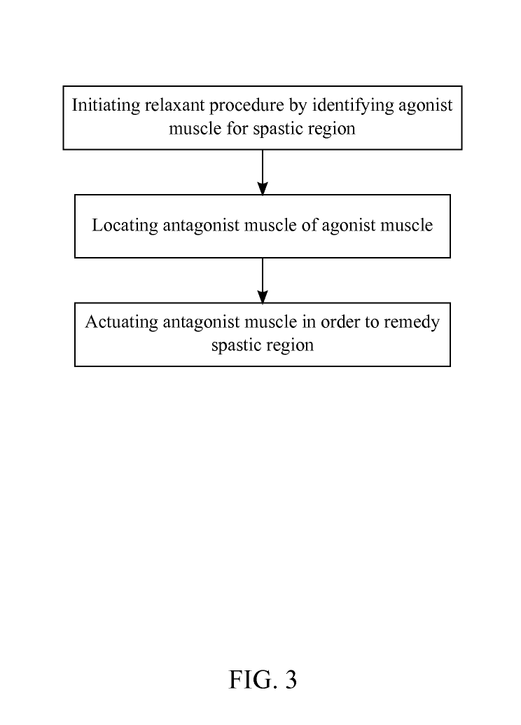

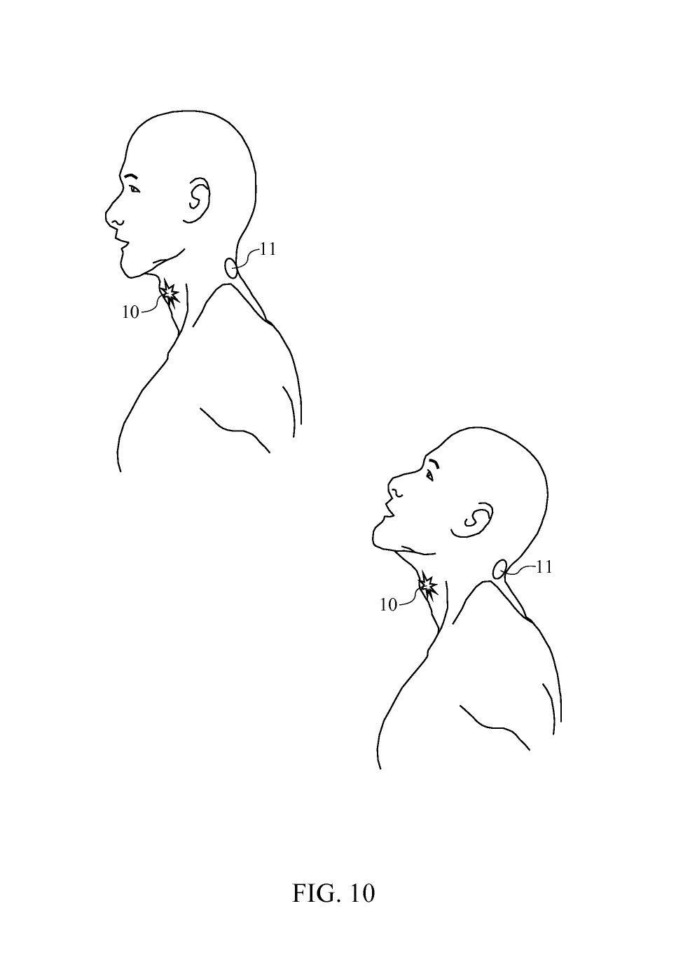

As can be seen in FIG. 3, the practitioner can also implement a relaxant procedure in order to remedy the painful region 3 if the pain region is a spastic region on the human body 1. A spastic region is usually an area on the human body 1 that is incapable of normally moving because of a sore or stiff muscle. The practitioner initiates the relaxant procedure by identifying the agonist muscle 10 for the spastic region, wherein the agonist muscle 10 is the sore or stiff muscle. For example, if a patient has difficulty flexing their arm, then the agonist muscle 10 is the biceps muscle located in that arm. The practitioner then locates the antagonist muscle 11 of the agonist muscle 10, wherein the antagonist muscle 11 is supposed to counter the movement of the agonist muscle 10. For example, the triceps muscle is the antagonist muscle 11 of the biceps muscle. Finally, the practitioner actuates the antagonist muscle 11 in order to remedy the spastic region. For example, if the agonist muscle 10 is the biceps muscle, then the practitioner stretches, holds, and releases the triceps muscle in order to remedy the spastic region in the biceps muscle. Another example situation is to bend the neck backwards if the spastic region is located at the front of the neck, which is illustrated in FIG. 10.

Thus, using the method of the present invention yields a plethora of benefits over traditional methods of treating conditions. These benefits include, but are not limited to, faster pain relief, greater range of motion, faster recovery from injury, reduced body stress, faster recovery from surgery, increased flexibility, increased mobility, reduced number of required treatments for recovery, and less pain from scarring.

Although the invention has been explained in relation to its preferred embodiment, it is to be understood that many other possible modifications and variations can be made without departing from the spirit and scope of the invention as hereinafter claimed.

What is claimed is:

1. A therapeutic method of indirectly relieving localized pain, the method comprises the steps of:
providing a human body as a patient, wherein said human body is symmetrically and bilaterally defined by a mid-sagittal plane, whereby said human body is anatomically defined as a plurality of body parts;
identifying a painful region on a specific body part of said human body;
ranking severity of said painful region;
locating a mirroring region for said painful region across said mid-sagittal plane;
stimulating said mirroring region on said human body in order to remedy said painful region;
locating a first contralateral region for said painful region about said specific body part;
stimulating said first contralateral region on said specific body part in order to remedy said painful region;
implementing a joint pain-relief procedure in order to remedy said painful region,
if said painful region is located at a joint for the human body; and
implementing a relaxant procedure in order to remedy said painful region,
if said painful region is a spastic region on the human body.

2. The therapeutic method of indirectly relieving localized pain, the method as claimed in claim 1, wherein said specific body part is selected from a group consisting of a head, a neck, a torso, a left arm, a left elbow, a right arm, a right elbow, a left leg, a left knee, a right leg, and a right knee.

3. The therapeutic method of indirectly relieving localized pain, the method as claimed in claim 1 comprises the step of:
ranking severity of said painful region on a scale of 0 to 10, wherein a ranking of 0 represents no pain and a ranking of 10 represents extreme pain.

4. The therapeutic method of indirectly relieving localized pain, the method as claimed in claim 1 comprises the step of:
stimulating said mirroring region by pressing and massaging said mirroring region on said human body for 30 to 60 seconds.

5. The therapeutic method of indirectly relieving localized pain, the method as claimed in claim 1 comprises the step of:
stimulating said first contralateral region by pressing and massaging said first contralateral region on said human body for 30 to 60 seconds.

6. The therapeutic method of indirectly relieving localized pain, the method as claimed in claim 1 comprises the step of:
further stimulating areas around said first contralateral region on said human body in order to remedy said painful region.

7. The therapeutic method of indirectly relieving localized pain, the method as claimed in claim 1 comprises the steps of:
initiating said joint pain-relief procedure by identifying an opposite body part to said specific body part, wherein said mirroring region is on said opposite body part;
locating a second contralateral region for said mirroring region about said opposite body part;
locating a proximal muscle group for said second contralateral region on the human body; and
stimulating said proximal muscle group in order to remedy said painful region.

8. The therapeutic method of indirectly relieving localized pain, the method as claimed in claim 1 comprises the steps of:
initiating said relaxant procedure by identifying an agonist muscle for said spastic region;
locating an antagonist muscle of said agonist muscle; and
actuating said antagonist muscle in order to remedy said spastic region.
